(19) United States
(12) Patent Application Publication
(10) Pub. No.: US 2015/0189356 A1
(43) Pub. Date: Jul. 2, 2015

(54) Personal Device Enhancement System with Dynamic Application Execution Mechanism and Method of Operation Thereof

(71) Applicant: Motorola Mobility LLC, Chicago, IL (US)

(72) Inventor: Howard H. Shen, Los Altos, CA (US)

(73) Assignee: Motorola Mobility LLC, Chicago, IL (US)

(21) Appl. No.: 14/247,562

(22) Filed: Apr. 8, 2014

Related U.S. Application Data
(60) Provisional application No. 61/921,588, filed on Dec. 30, 2013.

(51) Int. Cl. H04N 21/41; H04N 21/61; H04N 21/414

(52) U.S. Cl. CPC H04N 21/4126; H04N 21/4122; H04N 21/41407; H04N 21/6156

(57) ABSTRACT

A personal device enhancement system and method of operation thereof including: a personal device including: a processing unit for determining a primary device context; a storage unit for storing a user profile; a wireless interface unit for receiving secondary device properties from a display device; and wherein the processing unit is for generating customized content based on the primary device context, the user profile, and the secondary device properties for display on the display device.

### TECHNICAL FIELD

The present invention relates generally to a personal device enhancement system, and more particularly to a system for dynamic execution of applications.

### BACKGROUND ART

Modern portable consumer and industrial electronics, especially client devices such as navigation systems, smartphones, portable digital assistants, and other smart mobile devices, are providing increasing levels of functionality to support modern life including personalized information services. Research and development in the existing technologies can take a myriad of different directions.

As users become more empowered with the growth of mobile devices and storage and easy access to personalized information, new paradigms can arise to take advantage of this new space. There are many technological solutions to take advantage of the vast amount of data generated by each person in the course of their daily lives. One existing approach is to use location information to provide navigation services such as a global positioning system (GPS) for a car or on a mobile device such as a smartphone. Another approach is to use personal profiles and personalized data of a user to deliver customized productivity tools, content, and advertising to the user on their mobile device, such as a smartphone. However, due to the requirement that personal devices need to be small enough to easily carry around, there is a limit to how large the screen of a mobile device can be, if there is any screen at all.

Thus, a need still remains for improving presentation of personalized information. In view of the rapid increase in data collection and ubiquity of mobile devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a personal device enhancement system including: providing a personal device having a user context; receiving secondary device properties from a display device; and generating customized content with the personal device based on the user context and the secondary device properties for display on the display device.

The present invention provides a personal device enhancement system, including: a personal device including: a processing unit for determining a primary device context; a storage unit for storing a user profile; a wireless interface unit for receiving secondary device properties from a display device; and wherein the processing unit is for generating customized content based on the primary device context, the user profile, and the secondary device properties for display on the display device.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a personal device enhancement system with dynamic application execution mechanism in an embodiment of the present invention.

FIG. 2 is an operational flow of the personal device enhancement system.

FIG. 3 is an example of customized content displayed on the display device.

FIG. 4 is a flow chart of a method of operation of a personal device enhancement system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the lower edge of a screen, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures.

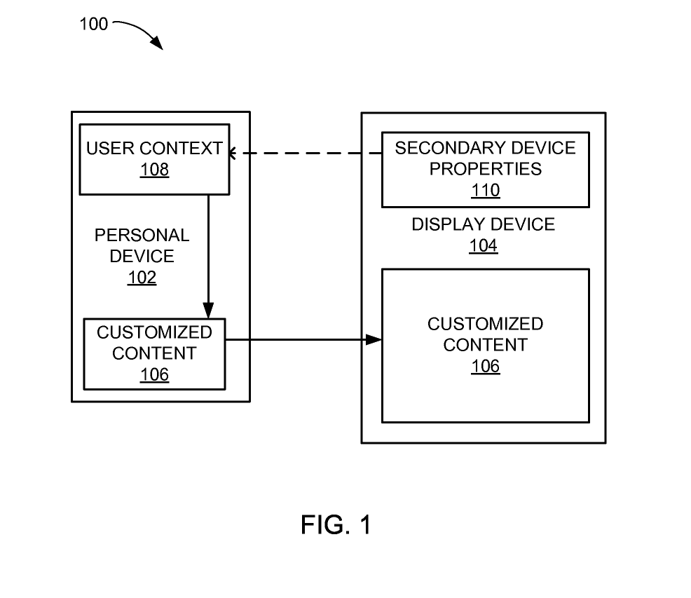

Referring now to FIG. 1, therein is shown a personal device enhancement system 100 with dynamic application execution mechanism in an embodiment of the present invention. The personal device enhancement system 100 is shown with a personal device 102 wirelessly connected to a display device 104.

The personal device 102, which can also be called the primary device, can be any device containing personal information of a user. For example, the personal device 102 can be a smartphone, feature phone, smartwatch, tablet, “phablet,” or other mobile device carried by consumers. The personal device 102 can be wirelessly connected to the display device 104 through various wireless communication protocols or short-range radio frequency communication protocols such as WiFi™, Bluetooth™, etc.

The display device 104 can be a display screen of any size, but, the display device 104 can have a display size larger than that of the personal device 102, for example. The display device 104 can also have a display size smaller than that of the personal device 102, for example. As another example, the personal device 102 may have no display at all. The display device 104, which can also be known as the secondary device, can function to display customized content 106 based on a user context 108 and secondary device properties 110. The customized content 106 can be generated or driven by the personal device 102 and merely displayed on the display device 104, for example.

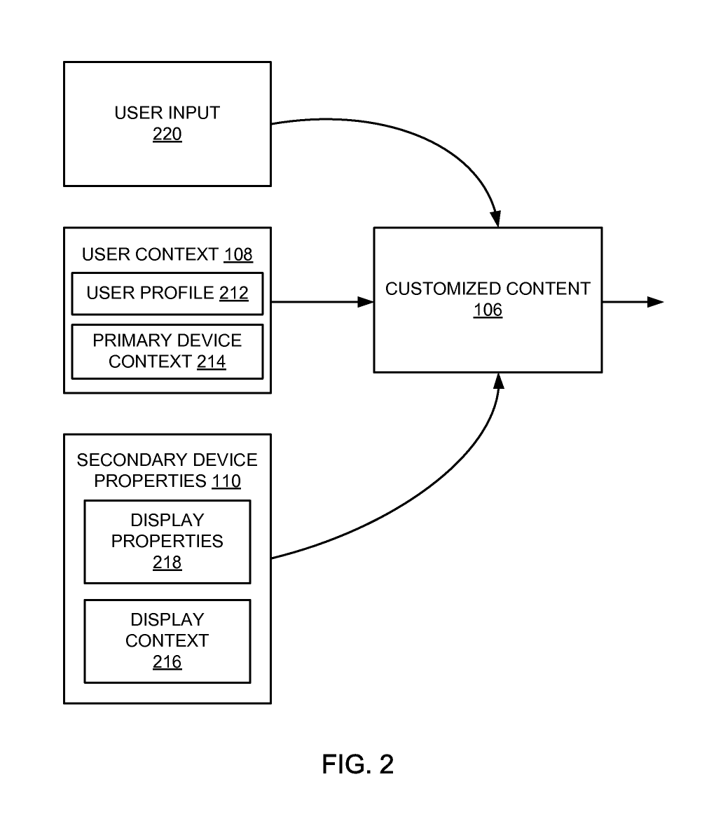

The personal device 102 can drive the display device 104 in various ways. For example, the personal device 102 can first wirelessly connect to the display device 104 and obtain the secondary device properties 110 of the display device 104. The personal device 102 can automatically generate the customized content 106 based on the user context 108 and the secondary device properties 110. The customized content 106 can be generated to be appropriate for the user and the location and capabilities of the display device 104. For example, the customized content 106 can be pre-generated or buffered within the personal device 102 based on the capabilities and sizes of the types of the display device 104 likely to be in a given location. Then, the customized content 106 can be sent or pushed to the display device 104 for display, for example. The generation of the customized content 106 is described in greater detail in the description of FIG. 2.

Referring now to FIG. 2, therein is shown an operational flow of the personal device enhancement system 100. The personal device enhancement system 100 can, within the personal device 102 of FIG. 1, combine at least the user context 108 and the secondary device properties 110 to generate the customized content 106 for pushing to the display device 104 of FIG. 1. The user context 108 includes a user profile 212 from the personal device 102 and a primary device context 214 of the personal device 102. The secondary device properties 110 include a display device context 216 and display properties 218 of the display device 104 such as the display size and screen capabilities.

For example, the personal device 102 can combine the secondary device properties 110 with the user profile 212 which has been already stored as part of the user context 108 to generate the customized content 106. The user profile 212 can be personalized information about the user of the personal device 102. For example, the user profile 212 can contain information about the user such as favorite TV shows, favorite sports and favorite sports teams, home location, work location, music preferences, alarm settings, a user schedule/calendar, friends, friends frequently contacted, travel patterns, or other user preferences or information. If the personal device 102 is a smartphone, for example, the smartphone may contain information about the user such as bank balances, buying habits, and have access to vast amounts of information about the user and the user's friends through connections to social networks. The user profile 212 may also contain biometric or measured content about the user such as heart rate, steps taken in a day, a determined stress level, or other quantitative information about the user.

The secondary device properties 110 (the display device context 216 and the display properties 218) can affect the display of the customized content 106. Examples of the display device context 216 include the location and properties of the location of the display device 104 such as a user's work office, a user's home office, a user's home's bathroom/kitchen/bedroom, or other locations such as restaurants, movie theaters, museums, an office, or school. The display device context 216 can also include the owner or operator of the display device 104, for example. Examples of the display properties 218 are screen size which can include 10 inches, 13 inches, 20 inches, and larger sizes such as 50 inches. The display properties 218 can also include screen capabilities which describe the various capabilities of the display device 104 such as whether the display device 104 has speakers, the resolution of the display screen, the pixel density of the display screen, and whether the display device 104 has touch capabilities, as just a few examples.

The combination of the display properties 218 of the secondary device properties 110 with the user profile 212 can allow the personal device 102 to automatically generate and display the customized content 106—context-relevant information to the user—on the display device 104. For example, if the user profile 212 shows the user enjoys sports or frequently reads sports news in the bathroom of the user's home, and the display properties 218 indicate that the display device 104 in the bathroom has a larger display than the screen of the personal device 102, the personal device 102 can automatically activate the display device 104 and cause the display device 104 to display sports news, currently playing games that fit the preferences of the user profile 212, highlights from the previous day that the user has not seen, or some combination thereof. The display device 104 can act as a second screen for the personal device 102, or the other way around, for example.

Continuing the example, user input 220 can affect what is being shown on the display device 104 and allow the user to further customize the customized content 106 to their preference. The personal device 102 can automatically show a remote control interface when a sports game is showing on the display device 104, or the other way around, as one example. The personal device 102 can also listen for voice commands through the display device 104 if the display properties 218 indicate that a microphone is present in the display device 104, or the personal device 102 can listen for voice commands directly, as another example. In both cases, the user input 220 can change or customize further the customized content 106 that is being displayed on the display device 104 or the personal device 102. The user can fast-forward the game or jump to the highlights if short on time, as a more concrete example.

As another example, if the personal device 102 detects that the display device 104 close to the personal device 102 has been designated as the bedroom e-reader (the display properties 218 of an e-ink screen, around 7 inches in size, for example), the personal device 102 can automatically open the relevant e-reader application on the display device 104. The user profile 212 can contain information about the last book read by the user, and the page the user stopped reading on. The personal device 102 can allow the user to resume reading an e-book started on the personal device 102 on the display device 104, which may have a screen more suited to reading than the personal device 102, for example.

As a further example, if the personal device 102 detects that the user is at work through the primary device context 214 of the user context 108 (for example, detected through GPS, geo-fencing the company campus, or proximity to company wi-fi), and the display properties 218 of the nearest display device 104 indicate a computer monitor of sufficient size, the personal device 102 can open the last-used work applications or enter into a work mode that will block incoming social media requests or messages temporarily. The primary device context 214 can include location data or sensor data determined through a GPS module, accelerometers, cameras in the personal device 102, for example. The primary device context 214 can also include the properties of the personal device 102 such as screen buffer memory limits, device capabilities (ability to run two, three, or more screens simultaneously), device screen sizes, or other properties about the personal device 102 itself. The personal device 102 can act as the “brain” for the display device 104 in the user's office, allowing the personal device 102 to power the content displayed on the display device 104. For example, the personal device 102 can open an email client for display on the display device 104.

It has been discovered that the user context 108 used by the personal device 102 to display the customized content 106 (work-relevant information, in this example) on the display device 104 improves the user experience and productivity. For example, because the user will nearly always have the personal device 102 with them, and the personal device 102 already contains user preferences within the user profile 212, the user can sit at any workstation or “thin” client and get to work immediately without any lengthy configuration or setup process, as the personal device 102 (already configured the way the user likes it) is powering the display device 104. Continuing the example, the personal device 102 can pre-generate or buffer work-related content or applications before the user sits at a workstation by detecting through the primary device context 214 of the user context 108 that the user is approaching or has arrived at his or her work location. This allows the user to instantly begin working once arriving at the workstation or thin client because the customized content 106 has already been buffered or pre-generated. Also for example, because the personal device 102 can be a device like a smartphone, functionality related to social media or messaging can be temporarily blocked from interrupting the user's work for an automatically determined or preset period of time.

The secondary device properties 110 of the user context 108 can be refined with the display context which can include local properties such as time of day, weather, traffic, nearby events, or even other personal devices in the vicinity. For example, if the user is at a mall with the personal device 102 and passes the display device 104 (in this example, a large display in a storefront) that can be seen from the front of a store, the personal device 102 can associate or connect with the display device 104 and display on the display device 104 an ad or coupon relevant to the store and the user's preferences. However, it is unlikely for only one of the personal device 102 to be close to the display device 104; there may be any number of the personal device 102 within viewing distance of the display device 104. In that case, all of the personal devices 102 can connect to the display device 104 and can cycle through relevant display content, the screen can be split depending on the relative locations of the personal devices 102 for maximum viewability, the closest of the personal device 102 or one which is the most stationary can be given priority, or other method of determining which of the personal devices 102 will control the display device 104 can be used. For example, the display device 104 can determine which of the personal devices 102 are closest and prioritize based on distance. Also for example, the display device 104 can use sensor data to determine which of the personal devices 102 are associated (in close proximity to) with a person who is looking towards the display device 104 through a process such as facial recognition. As an additional example, the coupon or ad can be “floated” above the standard content on the display device 104 and can “follow” the user (carrying the personal device 102) until the user is out of range as determined by sensors connected to or integral with the personal device 102, the display device 104, or both.

The personal device 102 powering the display device 104 can automatically tailor the customized content 106 on the display device 104 to match with the display properties 218 of the secondary device properties 110. For example, if the display device 104 has speakers, the personal device 102 can send audio as well as video to the display device 104. If the display device 104 does not have speakers, the personal device 102 can send video only, and if necessary, modify the content to allow consumption of the content without audio—as an example, a TV show can be presented on the display device 104 lacking speakers with closed captions automatically activated. Extending the example, if the display device 104 is under 11 inches, the personal device 102 can send 720p content, but if the display device 104 is over 20 inches, for example, the personal device 102 can cause the display device 104 to show 1080p video.

The user can set preferences for each screen (the user input 220) through an interface on the personal device 102 or even on the display device 104 if the display device 104 is detected to have touch capabilities. For example, the user can set the display device 104 having an e-ink display to always signal the personal device 102 to start up the user's e-reader application, regardless of the location of the personal device 102 or the display device 104. Also for example, if the personal device 102 is a smartphone, the personal device 102 can be set to always create an interface on the display device 104 that is touch-enabled and has a display size of between 7 and 10 inches such that tablet-sized application assets are used rather than assets sufficient for a 4.5 inch smartphone. This can mean the use of higher resolution art, larger fonts, better audio assets, a choice of appropriate content (start movie/read the news/watch the news/sports/etc.) or other modifications to how applications are presented on the display device 104 as compared to the personal device 102. In this and other ways, the functionality of the personal device 102 is not merely mirrored on the display device 104—the content is modified to best match with the display properties 218 of the display device 104, the user input 220 if given, and the user profile 212 (i.e., modified to match with the combination of the user context 108 and the secondary device properties 110).

As another example, the personal device 102 can use the user context 108 to customize displayed content once connected to the display device 104 without the user having to do anything. In other words, if the personal device 102 is in the user's pocket or bag, the user will not have to look at or even touch the personal device 102 for content to be displayed on the display device 104. The personal device 102 can automatically activate upon discovery of the display device 104 and display or push appropriate content such as sports scores or a live game, recipes if near the display device 104 in the kitchen, reminders overlaying content if a scheduled appointment is approaching, or other content based on the user context 108 and the secondary device properties 110. Further, the personal device 102 can activate and drive the customized content 106 to the display device 104 even if the user is already using the personal device 102. For example, the personal device 102 can generate and draw two separate screen buffers—one with content for display on the personal device 102, and another with the customized content 106 to be displayed on the display device 104. In this way, the personal device 102 alone can generate the customized content 106 while using the display device 104 as a second screen in a smart manner.

In other words, the content displayed on the display device 104 is not simply adjusted or mirrored content that would be shown on the personal device 102, the displayed content is appropriate to the display properties 218 and the user profile 212 as combined by the personal device 102; for example, if the user is speaking on his or her smartphone (the personal device 102), and is nearby the display device 104, the personal device 102 can cause the display device 104 to display the user's calendar for quick reference. If the user is speaking to his spouse or a person contacted at a high frequency, the display device 104 can be caused to display other content besides a calendar such as suggested gifts (if a holiday or birthday is approaching), a profile of the person on the other end of the phone call, or simply reminders of past events with the other person such as pictures where both the user and the person on the other end are present.

It has been discovered that the personal device 102 driving the display of the display device 104 without simply mirroring the displayed content of the personal device 102 can increase functionality of the personal device 102 and improve the user experience. For example, if the user wants to watch a streamed movie, the small screen of the personal device 102 (which could even be something as small as a smartwatch) can be insufficient for comfortable use. The movie could be streamed through the personal device 102 and onto the display device 104 having a much larger screen (where the display device 104 is a large television of over 20 inches, for example) at a higher resolution than what the personal device 102 could show. Continuing the example, if the display properties 218 of the display device 104 indicate a connection to a surround sound system, the audio streamed to the display device 104 from the personal device 102 can be sent in a surround sound compatible format rather than only in stereo. A movie selection interface could be shown automatically on the display device 104 by the personal device 102 if the user context 108 is determined to be appropriate (including time of day, prior user actions on the display device 104 in question, and the size of the display of the display device 104, as a few examples) prior to streaming the movie through the personal device 102.

The personal device 102 can include a number of hardware and software modules for detecting and driving the display device 104. For example, the personal device 102 can include a processing unit having interconnected modules, a storage or memory unit for storing the user profile 212 and the secondary device properties 110, and a wireless interface unit or transmitter for initiating and maintaining a wireless connection. The modules can be connected and operate in various ways. For example, a user context module can combine the user profile 212 and the primary device context 214 to generate the user context 108. A content generation module coupled to the user context 108 module can use the user context 108 and the secondary device properties 110 to generate the customized content 106 for display on the display device 104, for example. Various other modules can perform other necessary steps to determine whether to send sports scores or start an e-book reader, for example.

Some more examples of how the personal device enhancement system 100 can function are listed in Table 1 below. These examples are not intended to be limiting and are for illustrative purposes only.

TABLE 1

| Primary | | | |
|---|---|---|---|
| device (the | Secondary device | Location of | |
| personal | (the display device | secondary | |
| device 102) | 104) | device | Use case/User benefit |
| Mobile | Tablet-sized device | Home: In | When user is in bed or getting ready for |
| phone/device | that spends most of its | bedroom | bed, he likes to read books in his |
| | time in the bedroom | | electronic library. Primary device |
| | next to where the user | | knows the user profile 212 and knows |
| | sleeps | | what reading content is owned by user |
| | | | and projects eBooks to secondary |
| | | | screen. |
| Mobile | Tablet-sized screen | Home: In | When user is on the can, he likes to |
| phone/device | that is mounted to | bathroom | watch SportsCenter. His primary |
| | wall across from the | | device knows how to stream this |
| | toilet in the user's | | content from the internet and push it to |
| | home (could also | | the secondary device. Alternatively, |
| | apply to office/public | | user's wife likes to read articles on the |
| | toilet stall). | | NYTimes when on toilet. Wife's |
| | | | primary device will download and |
| | | | project NYTimes content to the same |
| | | | screen when she is near the secondary |
| | | | screen. |
| Mobile | 50″ LCD display in a | Office: In | User's primary device can sense and |
| phone/device | 12-person conference | conference | automatically send presentation |
| or Laptop | room. | room. | material to the conference room display |
| | | | without having to physically connect |
| | | | with cables. Concept of a second screen |
| | | | is clear to primary device such that |
| | | | personal notifications (such as personal |
| | | | chats, incoming email, facebook alerts, |
| | | | etc.) are not displayed on the |
| | | | presentation screen. |
| Mobile phone | 32″ LCD display on | Office: On | When user arrives at his desk at the |
| or laptop | user's desk at the | desk | office, the secondary device instantly |
| | office | | lights up and has a window opened for |
| | | | work email and the last three |
| | | | documents that the user has worked on. |
| Mobile | 70″ LCD display at | Public: | As user walks by large display at the |
| phone/device | airport. | Airport | airport which is showing a very long |
| | | terminal | list of departing flight information. As |
| | | | the user walks by and the secondary |
| | | | screen is detected by the primary |
| | | | device (and vice versa), a small, |
| | | | floating box appears on the secondary |
| | | | screen that “follows” the user as they |
| | | | walk by. The small, floating box shows |
| | | | just the flight information for the user. |
| | | | When the user passes the secondary |
| | | | display (no longer obscuring the view |
| | | | of others), the floating box, too, will |
| | | | disappear. |
| Mobile | 50″ LCD display at | Public: Mall | As the user approaches the secondary |
| phone/device | mall in the Gap | | display, the display starts to show |
| | window. | | advertisement that is relevant to the |
| | | | user rather than generic advertising. |

It has also been discovered that the personal device 102 connecting to the display device 104 and generating the customized content 106 based on the user context 108 and the secondary device properties 110 improves the user experience and reduces waste. Because the customized content 106 shown on the display device 104 is customized based on the user profile 212 of the personal device 102, one of the display device 104 can be shared among multiple users. As in the above example of the display device 104 in the bathroom, the display device 104 can be shared easily between the user and his or her spouse without any additional interaction necessary from any user. In other words, without increasing the number of logins, passwords, personal accounts, or devices, and without requiring logging out or logging in, the display device 104 can be easily shared between multiple users; this is not possible with current devices which at a minimum require the user to log the last user out and log themselves in to gain access to a desired user profile or settings.

Thus, it has been discovered that the personal device enhancement system 100 with dynamic application execution mechanism of the present invention furnishes important and heretofore unknown and unavailable solutions, capabilities, and functional aspects for effectively utilizing the power users carry around with them in the personal device 102. The personal device enhancement system 100 also allows for simplification of the display device 104 since the personal device 102 alone is generating and pushing the customized content 106 onto the display device 104.

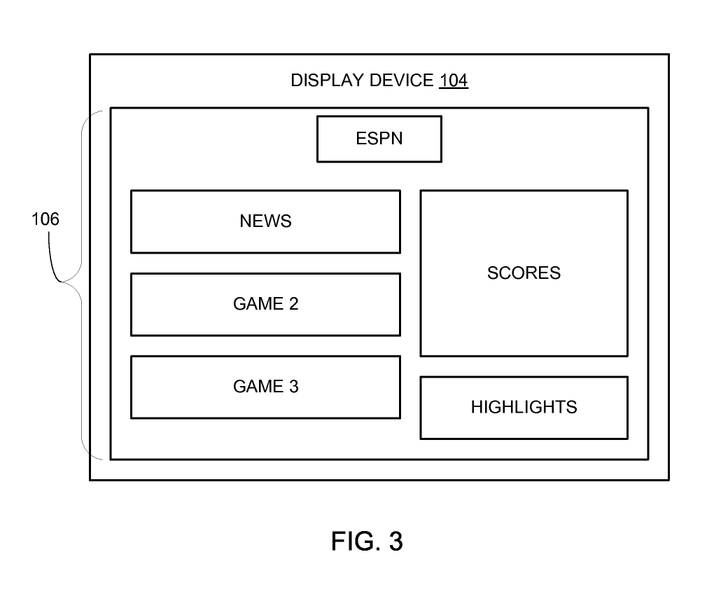

Referring now to FIG. 3, therein is shown an example of the customized content 106 displayed on the display device 104. This example shows in greater detail one possibility of the customized content 106 the personal device 102 of FIG. 1 can display through the display device 104.

Taking the example of automatically showing ESPN when the user and the personal device 102 enter the user's home bathroom, the display device 104 can display various things depending on the time of day, the most recent game, the user's favorite games, breaking news, or other items of interest. In this example, the ESPN header can be seen at the top of the display screen, and under the header can be categories broken out for quick perusal. Not all categories need to fit on a single screen, so scrolling may be implemented as necessary. The categories can be automatically generated or chosen by the user, but in this example they are a news block, two current game blocks, a score or game summary block, and a highlights block. The blocks can be arranged in any manner, and the user can customize the layout to suit their preferences. This is an example of the user input 220 of FIG. 2 modifying the customized content 106. This example can also be considered as a way for the user input 220 to modify the user profile 212 of FIG. 2; the types of things the user would like to see can be modified based on what the user chooses to remove or add to the automatically generated screen in this example. The personal device 102 can also learn which categories the user is most interested in and move frequently accessed categories to the top for easy access, for example.

The personal device 102 can also modify what is shown on the display device 104 in other ways. For example, the personal device 102 can automatically stream or cause the display device 104 to stream a currently playing game if the game meets certain criteria such as the user marking one of the teams playing as a favorite or home team and the personal device 102 is close enough to the display device 104. If the display device 104 is not controllable via touch or voice, the personal device 102 can also automatically enter into a remote control mode for navigating content on the display device 104, for example. As another example, the personal device 102 can display on the display device 104 highlights from a game that the user did not watch the next time the user is close enough to the display device 104 (in this example, the display device 104 in the user's home's bathroom).

It has been discovered that the personal device 102 displaying the customized content 106 through the display device 104 can improve usability of the personal device 102 and reduce costs. For example, because the display device 104 can be a device that does not need its own storage or a large amount of computing power, the display device 104 can be produced more cheaply than a full-featured tablet. In addition, because the personal device 102 may have a relatively small screen, viewing the customized content 106 on a larger display of the display device 104 can increase user enjoyment of content without requiring the user to customize or sync with every other display device 104 that is used throughout their daily lives. The user profile 212 is always present and usable to customize content because the user is likely to carry their personal device 102 with them. As a further example, because the access to the user profile 212 of the personal device 102 is already authenticated by the user, no separate logins or passwords are necessary for the user to remember, simplifying the process of customization, allowing easy and automatically available sharing of the display device 104. In addition, because the personal device 102 drives the content shown on the display device 104, the display device 104 can be manufactured to only have short-range wireless capability rather than needing additional hardware for independent connection to the Internet.

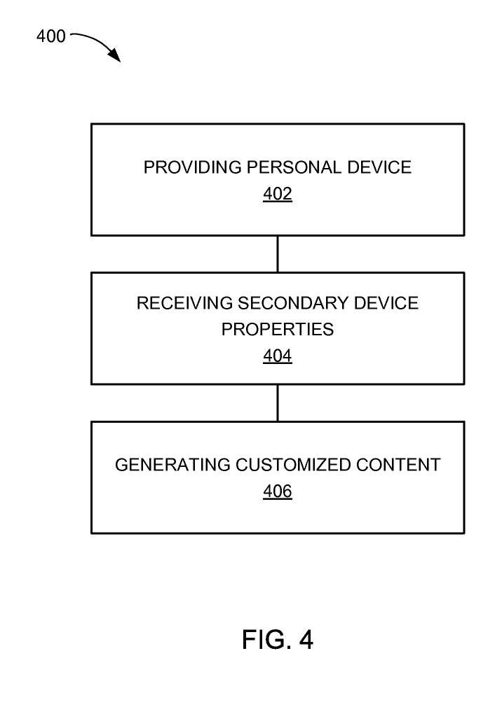

Referring now to FIG. 4, therein is shown a flow chart of a method 400 of operation of a personal device enhancement system in a further embodiment of the present invention. The method 400 includes: providing a personal device having a user context in a block 402; receiving secondary device properties from a display device in a block 404; and generating customized content with the personal device based on the user context and the secondary device properties for display on the display device in a block 406.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a personal device enhancement system comprising:
providing a personal device having a user context;
receiving secondary device properties from a display device; and
generating customized content with the personal device based on the user context and the secondary device properties for display on the display device.

2. The method as claimed in claim 1 further comprising detecting a user input for modifying the customized content.

3. The method as claimed in claim 1 wherein the user context includes:
a primary device context; and
a user profile.

4. The method as claimed in claim 1 wherein the secondary device properties include:
display properties; and
a display context.

5. The method as claimed in claim 1 further comprising:
initiating with the personal device a wireless connection to the display device; and
requesting with the personal device the secondary device properties from the display device.

6. A method of operation of a personal device enhancement system comprising:
providing a personal device;
determining with the personal device a user context including:
a primary device context, and
a user profile;
receiving secondary device properties from a display device, the secondary device properties including:
display properties, and
a display context; and
generating customized content with the personal device based on the user context and the secondary device properties for display on the display device.

7. The method as claimed in claim 6 further comprising:
detecting a user input;
modifying with the personal device the customized content based on the user input.

8. The method as claimed in claim 6 wherein the user profile includes:
user preferences; and
user social network information.

9. The method as claimed in claim 6 wherein the primary device context includes:
location information; and
personal device capabilities.

10. The method as claimed in claim 6 wherein generating the customized content includes:
determining with the personal device the primary device context to be in a user's home location;
determining with the personal device the user profile wherein the user enjoys watching sports in the user's home location;
receiving with the personal device the display properties of the display device as having speakers and a screen size of over 7 inches; and
generating with the personal device the customized content to have sports-related information.

11. The method as claimed in claim 6 further comprising:
detecting a user input;
modifying with the personal device the customized content based on the user input; and
updating the user profile based on the user input.

12. The method as claimed in claim 6 further comprising:
activating the display device with the personal device; and
pushing the customized content to the display device with the personal device.

13. The method as claimed in claim 6 further comprising:
determining with the personal device the display properties of the display device to lack touch capabilities; and
generating a remote control interface on the personal device for interacting with the customized content displayed on the display device.

14. The method as claimed in claim 6 wherein generating the customized content includes:
generating personal device content as a first screen buffer for display on the personal device; and
generating the customized content as a second screen buffer for display on the display device.

15. The method as claimed in claim 6 wherein generating the customized content includes:
generating video data for display on the display device; and
generating audio data for output from the display device.

16. A personal device enhancement system comprising:
a personal device including:
a processing unit for determining a primary device context;
a storage unit for storing a user profile;
a wireless interface unit for receiving secondary device properties from a display device; and
wherein the processing unit is for generating customized content based on the primary device context, the user profile, and the secondary device properties for display on the display device.

17. The system as claimed in claim 16 wherein the processing unit is for detecting a user input for modifying the customized content.

18. The system as claimed in claim 16 wherein the secondary device properties include:
display properties; and
a display context.

19. The system as claimed in claim 16 wherein the wireless interface unit is for:
initiating a wireless connection to the display device; and
requesting the secondary device properties from the display device.

20. The system as claimed in claim 16 wherein:
the processing unit is for generating personal device content as a first screen buffer and generating the customized content as a second screen buffer; and
the wireless interface unit is for sending the customized content to the display device.
